(19) United States
(12) Patent Application Publication
(10) Pub. No.: US 2003/0184990 A1
(43) Pub. Date: Oct. 2, 2003

(54) Light-guiding plate module of high reliability

(76) Inventor: Chia-Feng Lin, Chunan Maioli (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/105,241

(22) Filed: Mar. 26, 2002

(51) Int. Cl. F21V 7/04

(52) U.S. Cl. 362/31; 362/27

(57) ABSTRACT

The present invention proposes a light-guiding plate module of high reliability to provide a required uniform light source for a display. The light-guiding plate module comprises a single or at least two light-transmitting plates. Each light-transmitting plate comprises an upper and a lower light-guiding uniform plates. A light-focusing pattern and a light-intercepting pattern are formed on the upper and lower light-guiding uniform plates, respectively. At least a light-emitting source is disposed at least at a side of the light-transmitting plate. The light-guiding plate module of the present invention provides a light source of super-high brightness and good reliability for an LCD to apply to displays of control boards in cockpits of various kinds of vehicles.

### FIELD OF THE INVENTION

The present invention relates to a light source module of a liquid crystal display (LCD) and, more particularly, to a light-guiding plate module applicable to stringent environments for use as a backlight source or a front light source module of an LCD in cockpits of various kinds of vehicles.

### BACKGROUND OF THE INVENTION

Displays are the most direct sensory interfaces between humans and televisions and between humans and electronic/information products. They play the roles as output devices for showing pictures and texts. Along with development of liquid crystal displays, they have been used as displaying interfaces in vehicles such as airplanes, trains, and cars. For the present middle-size LCD used in vehicles, a cold cathode fluorescent lamp (CCFL) is primarily used as a backlight source or a front light source of the display. The projected light source passes through liquid crystal material with the penetrating angle of light through liquid crystal changed according to arrangement way of liquid crystal molecules, thereby achieving the object of displaying an image on a liquid crystal panel.

Although a CCFL has good displaying effect in terms of uniformity and brightness, an alternating-current (AC) power supplie of high voltage (˜1000 V) is required so that signals of other electronic devices and image signals of an LCD will be easily interfered by AC signals, hence generating bad displaying effect. Additionally, the characteristics of a CCFL will be affected by temperature so that the lifespan of a CCFL will be greatly reduced for vehicles entering rigorous regions such as deserts, snowing regions, and so on. Once a CCFL is damaged, the LCD using the CCFL as a back light source needs to be replaced. Moreover, because it is necessary to prepare several backup LCDs on a vehicle or to troubleshoot the vehicle, much space is wasted.

Accordingly, the present invention aims to propose a light-guiding plate module as a back light source or a front light source of an LCD.

### SUMMARY OF THE INVENTION

The primary object of the present invention is to propose a light-guiding plate module of high brightness and high reliability to provide the required light source for a display.

Another object of the present invention is to propose a light-guiding plate module of direct-current (DC) and low-voltage operation so that an LCD using it as a back light source or a front light source can have a very low operational voltage, thereby achieving power-saving object and having better displaying effect.

Yet another object of the present invention is to provide a light-guiding plate module not limited by temperature and thus having a longer lifetime of use so that it can be applied in important and safe displays of cockpits of various kinds of vehicles. The light-guiding plate module can be used even if the vehicle rides in rigorous environments.

To achieve the above objects, a light-guiding plate module of the present invention comprises a plurality of stacked light-transmitting plates and a light-emitting source at least disposed at a side of the light-transmitting plates. Each of the light-transmitting plates comprises an upper and a lower light-guiding uniform plates. A light-focusing pattern and a light-intercepting pattern are formed on the upper and lower light-guiding uniform plates, respectively. After light of the light-emitting source is uniformed and focused by the light-transmitting plates, a high-brightness light source is obtained. The light-emitting source can be selected from a field-emitting diode (FED) or a white-light light-emitting module generated or mixed by a light-emitting diode (LED) and an organic light-emitting diode (OLED). Additionally, the above design of a plurality of stacked light-transmitting plates can be replaced with a depressed light-transmitting plate and a reflective film disposed therebelow.

The various objects and advantages of the present invention will be more readily understood from the following detailed description when read in conjunction with the appended drawings, in which:

### BRIEF DESCRIPTION OF THE DRAWINGS

FIG. 1 is a diagram showing a three-dimensional structure of the present invention;

FIG. 2 is a cross-sectional view of the present invention;

FIG. 3 is a diagram of light-transmitting plates according to an embodiment of the present invention;

FIG. 4 is a diagram of light-transmitting plates according to another embodiment of the present invention;

FIG. 5 is a diagram of light-transmitting plates according to yet another embodiment of the present invention;

FIG. 6 is a diagram of light-transmitting plates according to still yet another embodiment of the present invention;

FIG. 7 is a diagram of a light-emitting source of the present invention;

FIGS. 8a to 8d are diagrams of another light-emitting source of the present invention; and

FIGS. 9a to 9b are diagrams of yet another light-emitting source of the present invention.

### DETAILED DESCRIPTION OF THE PREFERRED EMBODIMENTS

The present invention mainly uses a light-guiding plate module as a back light source or a front light source of an LCD to provide a light source module of super high-brightness, high uniformity, and good reliability for the LCD.

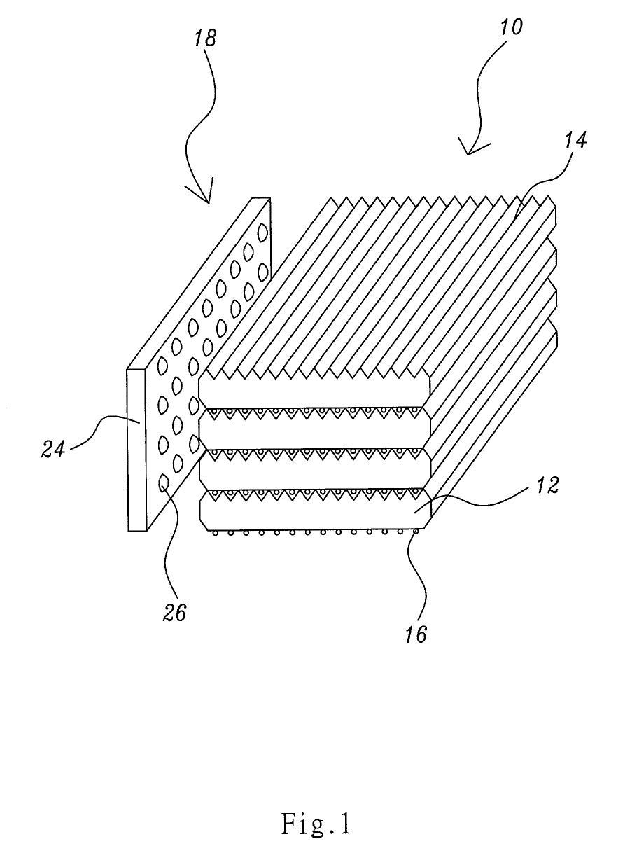

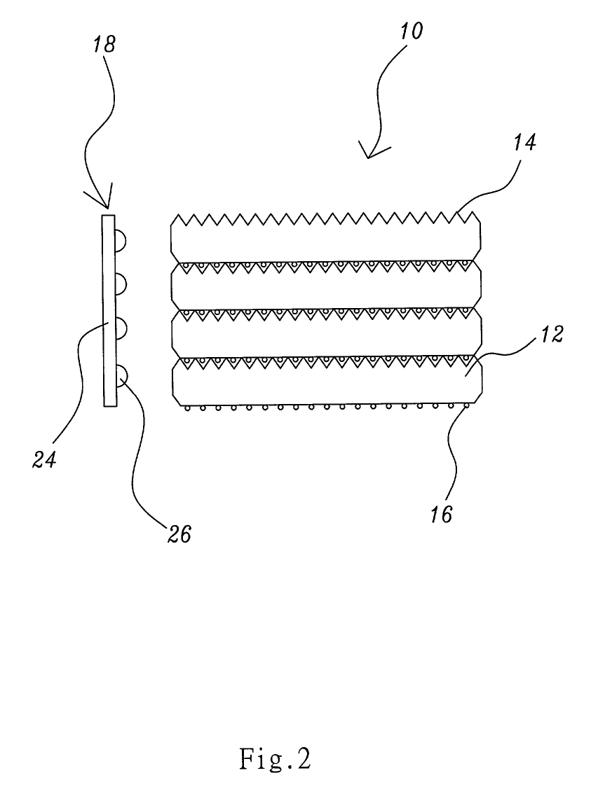

As shown in FIGS. 1 and 2, a light-guiding plate module 10 of high reliability comprises a plurality of light-transmitting plates 12 uniformly stacked up and down. Each of the light-transmitting plates 12 comprises an upper and a lower light-guiding uniform plates 14 and 16 parallel to each other. A light-intercepting pattern is formed on each of the lower light-guiding uniform plates 16 to let light source be uniform. A light-focusing pattern for focusing light is formed on each of the upper light-guiding uniform plates 14. A white-light light-emitting source 18 is disposed at a side of the light-transmitting plates 12 to let light source be incident into the light-transmitting plates 12 and be uniformed and focused by the light-transmitting plates 12 to generate a light source of high brightness and high uniformity, thereby providing the required front light source or back light source for a display. The light-focusing pattern is a V-shaped continuous groove pattern, and the light-intercepting pattern is a pattern of a plurality of distributed circular points.

The material of the above light-transmitting plates is selected among refractory and nonflammable materials such as optical grade acrylic, high molecule polymer, polycarbonate (PC), glass, or quartz. The material of the light-guiding rod can be optical grade acrylic, high molecule polymer, polycarbonate, glass, or quartz. In order to not generate loss when light propagates between two adjacent light-transmitting plates 12, a diffusive plate (not shown) and a prism (not shown) can be disposed between every two adjacent light-transmitting plates.

The light-emitting source 18 is formed by arranging a plurality of LEDs 26 in array on a circuit board. At least the position of each row of the LEDs 26 faces a side of each of the light-transmitting plates 12. Light source of the LEDs is uniformly incident into each of the light-transmitting plates 12, intercepted by the lower light-guiding uniform plate 16, and uniformly reflected to the upper light-guiding uniform plate 14. After being focused by the upper light-guiding uniform plate 14, the light is emitted out via the diffusive plate and the prism to enter another light-transmitting plate. The light then undergoes again the process of intercepting light, letting light be uniform, and focusing light. A light source module of super high brightness and high uniformity is thus formed.

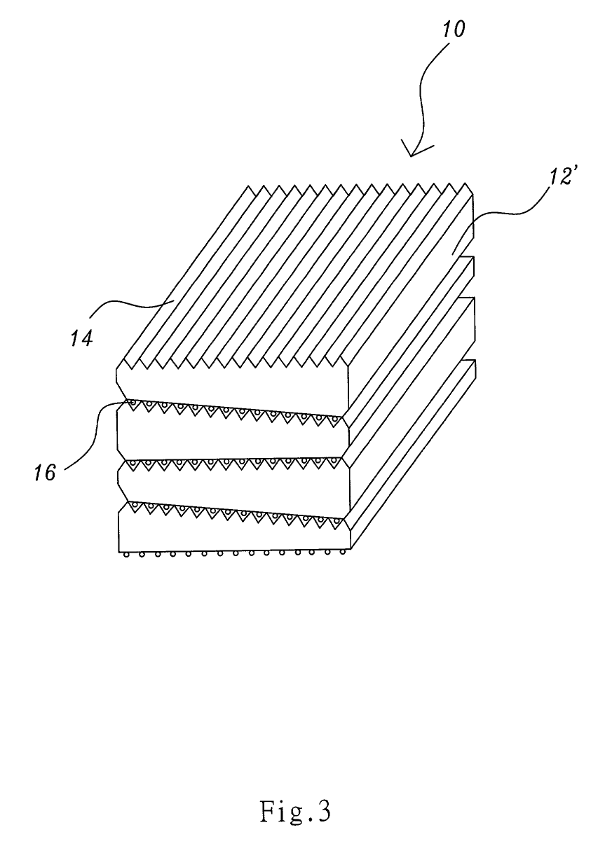

The light-guiding plate module 10 of the present invention can be formed by stacking one or a plurality of trapezoid light-transmitting plates 12′, as shown in FIG. 3. The upper light-guiding uniform plate 14 and the lower light-guiding uniform plate 16 of the light-transmitting plate 12′ are non-parallel disposed, one on a horizontal plane, one on a slanting plane. The light-emitting source 18 can be simultaneously disposed surrounding the light-transmitting plate 12′ to let light source be uniformly incident into the light-transmitting plate 12′.

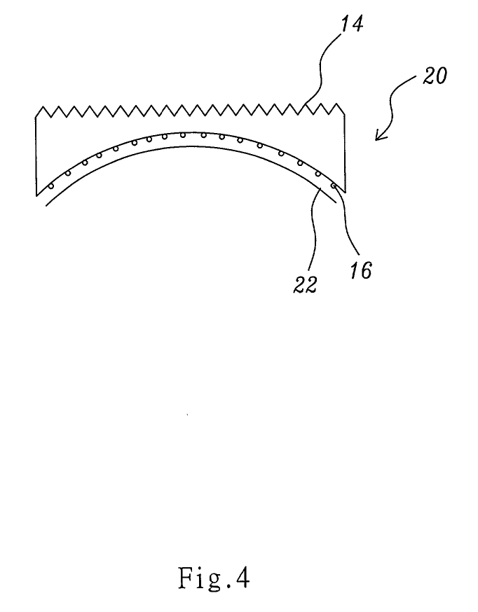

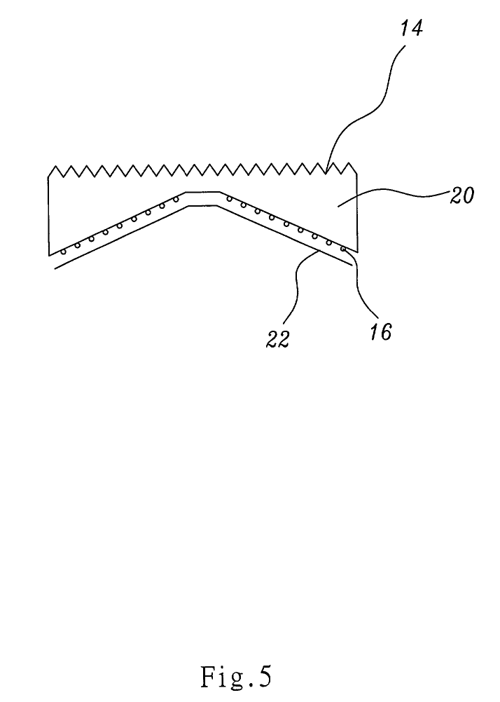

Additionally, in addition to providing uniform and focusing function by stacking a plurality of light-transmitting plates 12, a depressed light-transmitting plate 20 and a reflective film 22 can be used, as shown in FIG. 4. The depressed light-transmitting plate 20 comprises a horizontal upper light-guiding uniform plate 14 and a circular arc-shaped lower light-guiding uniform plate 16 depressed toward the upper light-guiding uniform plate 14. A light-focusing pattern and a light-intercepting pattern are formed on the upper and lower light-guiding uniform plates 14 and 16, respectively. The reflective film 22 having a shape corresponding to that of the lower light-guiding uniform plate 16 is disposed below the lower light-guiding uniform plate 16. Different curvatures of the lower light-guiding uniform plate 16 are exploited to reflect light to the surface of the upper light-guiding uniform plate 14. The shape of the light-transmitting plate 12 can a double-wedge shaped plate, as shown in FIG. 5. The upper light-guiding uniform plate 14 is horizontally disposed, and the lower light-guiding uniform plate is conically depressed. A light-focusing pattern and a light-intercepting pattern are formed on the upper and lower light-guiding uniform plates 14 and 16, respectively.

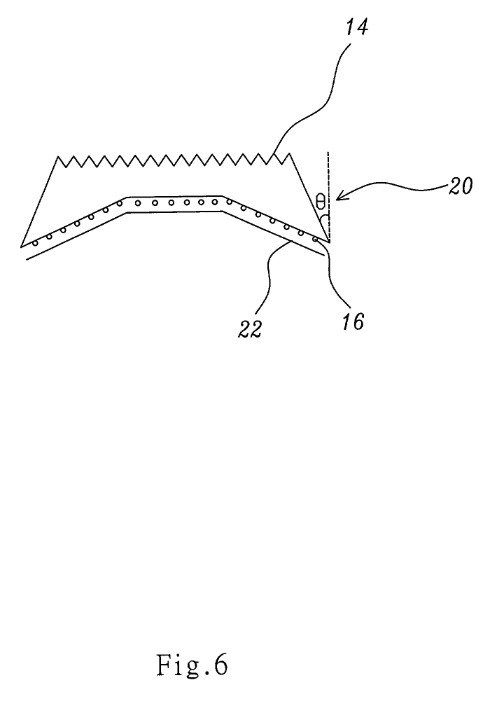

In the above depressed light-transmitting plate 20, the lower light-guiding uniform plate 16 can be paraboloidal, hyperboloidal, or multiply-curved surface shaped. The shape of the reflective film 22 corresponds to that of the lower light-guiding uniform plate 16. Additionally, as shown in FIG. 6, in addition to being vertical, the incident face of light source on two side faces of the depressed light-transmitting plate 20 can be a symmetric slanting plane with the slanting angle θ between 0 and 60 degrees. The light-emitting source 18 nestles up against the slanting plane so that the light source directly illuminates the reflective film 22 at the bottom, thereby effectively enhancing efficiency of usage of the light source. When manufacturing the depressed light-transmitting plate 20, the central thickness thereof needs to be increased along with increase of the slanting angle, thereby decreasing effect of shrinkage and deformation when material is ejected out to perform mold ejection of the light-transmitting plate.

In the light-transmitting plate 12 of the present invention, in addition to the pattern of V-shaped continuous grooves, the light-focusing pattern on the upper light-guiding uniform plate 14 can also be the pattern of V-shaped alternate grooves, the pattern of two sets of bars, or another pattern capable of focusing light. The angle between the direction of the light-focusing pattern and the incident direction of the light-emitting source is between 0 and 180 degrees. The two bars in the pattern of two sets of bars can be normal to each other. In addition to being the pattern of distributed circular points, the light-intercepting pattern on the lower light-guiding uniform plate 16 can be the pattern of distributed rectangular points, the pattern of distributed square points, the pattern of distributed hexagonal points, the pattern of distributed semicircular points, the pattern of distributed semilunar points, the pattern of semispherical raised points, the pattern of diamonds, the pattern of trapezoid grooves, the pattern of slantingly V-shaped continuous grooves, the pattern of V-shaped alternate grooves. The above light-focusing pattern and light-intercepting pattern of various shapes can be denser or sparser according to the distance from the light source to enhance efficiency of usage and uniformity of the light source.

The present invention utilizes the light-guiding plate module 10 to replace a conventional CCFL as a backlight source module or a front light source module of an LCD. In addition to providing the required super high brightness and high uniformity for a display, the present invention also has the characteristics of low power consumption, power saving, and super thinness. Moreover, the present invention is not limited by temperature so that it can apply to important and safe displays in cockpits of vehicles such as airplanes, helicopters, air fighters, trains, ships, or submarines. The present invention can be used as an important steering and positioning display to adapt to rigorous environments of high temperature, super low temperature, high humidity, or high pressure. Because the light-guiding plate module uses a large number of point-type light-emitting sources, if part of the light-emitting sources are damaged, the whole display is barely affected. Therefore, the present invention has the merits of high reliability and safety.

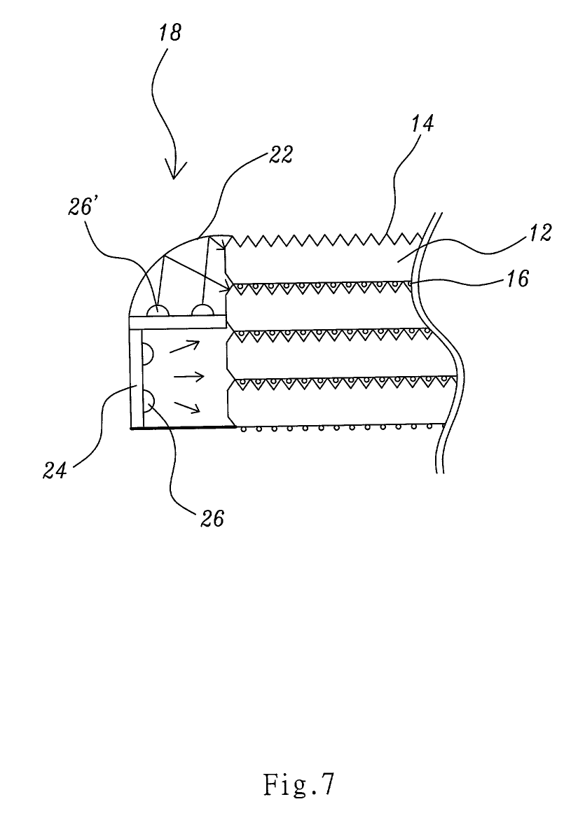

In addition to arranging the LEDs 26 in array as the light-emitting source, a vertically bent soft circuit board 24 can be disposed at a side of the light-transmitting plate 12, and a plurality of LEDs 26 are disposed on two bent planes of the circuit board 24, as shown in FIG. 7. Light source of the LEDs 26 on one of the two bent planes is directly incident into the region below the light-transmitting plate 12, while light source of the LEDs 26′ on the other bent plane is incident upwards, and is then reflected into region above the light-transmitting plate 12 by the arc-shaped reflective film 22 disposed on the periphery of the circuit board 24.

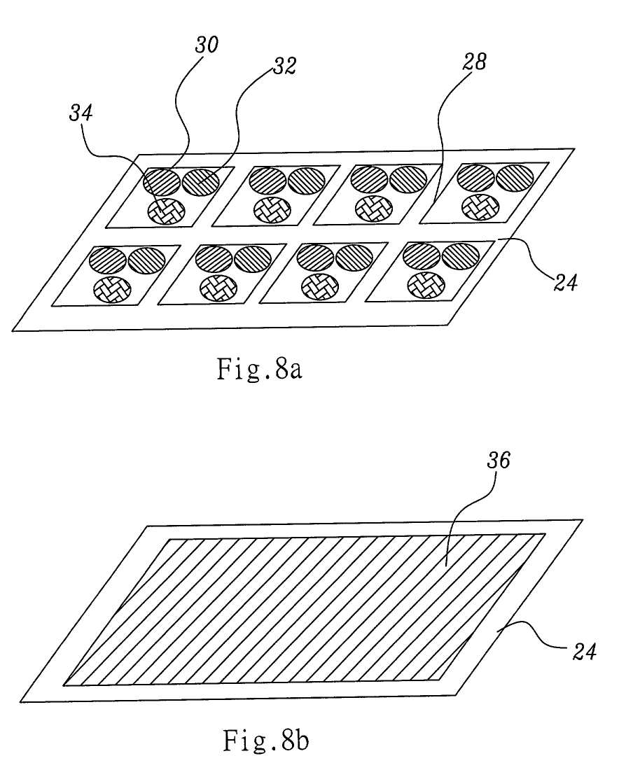

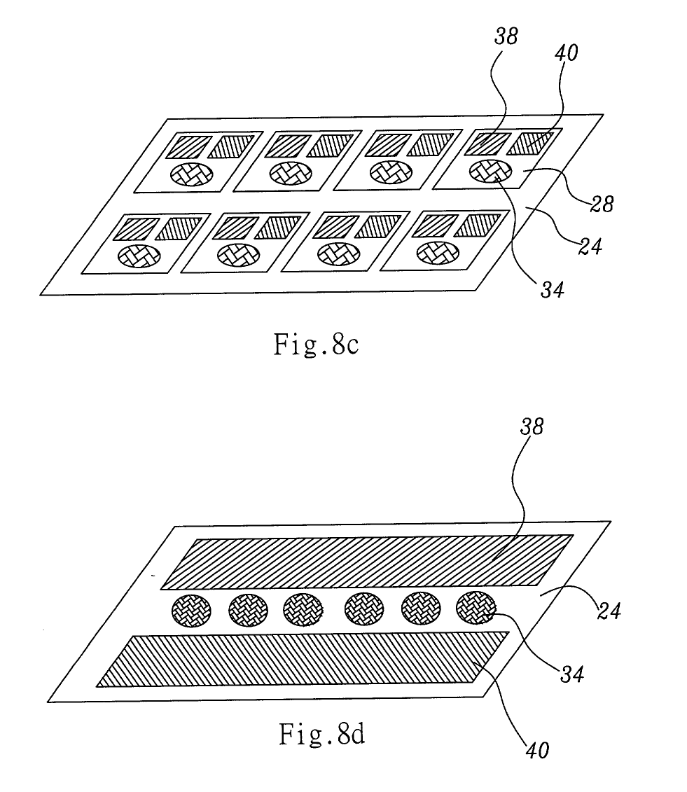

For the above light-emitting source 18, as shown in FIG. 8a, a plurality of light units 28 are uniformly formed on the circuit board 24. Each of the light units 28 is composed of a blue light LED 30, a green light LED 32, and a red light LED 34. Displaying effect of white light is achieved by adjusting the used number of LEDs. On the other hand, as shown in FIG. 8b, a whole-sheet OLED 36 or a whole-sheet electro-luminescence (EL) device emitting white light can be directly used as the light-emitting source.

Because the green light LED 40 and the blue light LED 38 are more expensive than the red light LED, and small-sheet OLED is cheaper than a whole-sheet OLED 36, the light-emitting source 18 can be designed as shown in FIG. 8c, wherein a light unit 28 is composed of a red light LED 34 a blue light OLED 38, and a green light OLED 40 so that white light can be combined. Or a plurality of long-sheet OLEDs uniformly selected from blue light OLEDs 38 and green light OLEDs 40 are parallel spaced and alternately arranged on a circuit board 24, as shown in FIG. 8d. Also, a plurality of red light LEDs 34 are uniformly disposed between each blue light OLED 38 and each green light OLED 40.

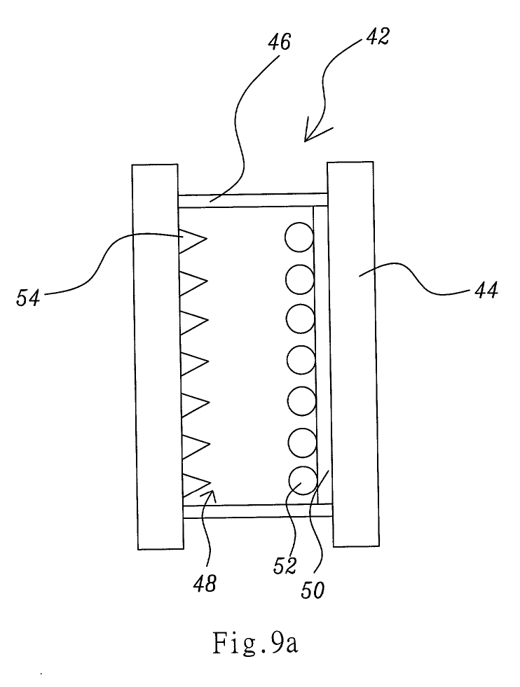

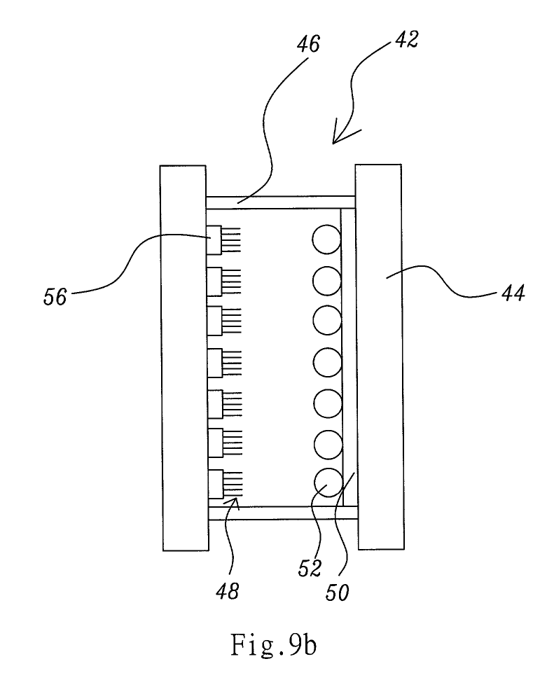

Additionally, as shown in FIG. 9a, the light-emitting source can be a FED module 42, which comprises two parallel glass substrates 44. Seal mouths 46 are disposed surrounding the glass substrate 44 to form a vacuum state. A field-emitting array composed of subulate FEDs 54 and a transparent electrode layer 50 are disposed on two opposed surfaces of the two glass substrates 44, respectively. A fluorescent layer 52 is disposed on the surface of the transparent electrode layer 50 corresponding to the field-emitting array 48. Through the subulate FEDs 54 emitting electrons at a low operational voltage, the fluorescent layer 52 emits white light to enter the light-transmitting plate 12. A diffusive plate (not shown) and a prism (not shown) can also be disposed between the FED module 42 and the light-transmitting plate 12. As shown in FIG. 9b, the subulate FEDs 54 can be replaced with field-emitting carbon nanotubes.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A light-guiding plate module of high reliability used to provide a required uniform light source for a display, said light-guiding plate module comprising:
at least two light-transmitting plates stacked up and down, each of said light-transmitting plates comprising an upper and a lower light-guiding uniform plates, a light-focusing pattern being formed on said upper light-guiding uniform plate, a light-intercepting pattern being formed on said lower light-guiding uniform plate; and
at least a light-emitting source disposed at least at a side of said light-transmitting plates.

2. The light-guiding plate module of high reliability as claimed in claim 1, wherein said light-transmitting plate can be a flat plate or a trapezoid plate.

3. The light-guiding plate module of high reliability as claimed in claim 1, wherein said light-focusing pattern can be a pattern of V-shaped continuous grooves, a pattern of V-shaped alternate grooves, or a pattern of two sets of bars.

4. The light-guiding plate module of high reliability as claimed in claim 1, wherein the angle between the direction of said light-focusing pattern and the incident direction of said light-emitting source is between 0 and 180 degrees.

5. The light-guiding plate module of high reliability as claimed in claim 3, wherein the two sets of bars in said pattern of two sets of bars are normal to each other.

6. The light-guiding plate module of high reliability as claimed in claim 1, wherein said light-intercepting pattern can be a pattern of distributed circular points, a pattern of distributed rectangular points, a pattern of distributed square points, a pattern of distributed hexagonal points, a pattern of distributed semicircular points, a pattern of distributed semilunar points, a pattern of semispherical raised points, a pattern of diamonds, a pattern of trapezoid grooves, a pattern of slantingly V-shaped continuous grooves, or a pattern of V-shaped alternate grooves.

7. The light-guiding plate module of high reliability as claimed in claim 1, wherein said light-focusing pattern and said light-intercepting pattern on said upper and lower light-guiding uniform plates can form denser or sparser patterns according to their distances from said light-emitting source.

8. The light-guiding plate module of high reliability as claimed in claim 1, wherein the material of said light-transmitting plate is selected among optical grade acrylic, high molecule polymer, polycarbonate, glass, and quartz.

9. The light-guiding plate module of high reliability as claimed in claim 1, wherein at least one of a prism and a diffusive plate is disposed between every two adjacent said light-transmitting plates.

10. The light-guiding plate module of high reliability as claimed in claim 1, wherein said light-emitting source is a matrix composed of a plurality of light-emitting diodes.

11. The light-guiding plate module of high reliability as claimed in claim 10, wherein said plurality of light-emitting diodes are composed of a plurality of red light light-emitting diodes, green light light-emitting diodes, and blue light light-emitting diodes.

12. The light-guiding plate module of high reliability as claimed in claim 1, wherein said light-emitting source is a whole-sheet white light organic light-emitting diode or a whole-sheet white light electroluminescence device.

13. The light-guiding plate module of high reliability as claimed in claim 1, wherein said light-emitting source is a plurality of light units formed on a circuit board, and each said light unit is composed of a blue light organic light-emitting diode, a green light organic light-emitting diode, and a red light light-emitting diode so that white light can be obtained by combining the three primary colors for use as a light source of said display.

14. The light-guiding plate module of high reliability as claimed in claim 1, wherein said light-emitting source is at least a long-sheet blue light organic light-emitting diode and at least a long-sheet green light organic light-emitting diode parallel spaced and alternately arranged on a circuit board, and a plurality of red light light-emitting diodes are uniformly disposed between each said blue light organic light-emitting diode and each said green light organic light-emitting diode.

15. The light-guiding plate module of high reliability as claimed in claim 1, wherein said light-emitting source is an FED utilizing electron beams to bombard a white light displaying light source composed of white fluorescent powder or combination of red, green, and blue fluorescent powder.

16. The light-guiding plate module of high reliability as claimed in claim 15, wherein a diffusive plate and a prism can be additionally disposed between said FED and said light-transmitting plate to enhance uniformity of light incident into said light-transmitting plate.

17. The light-guiding plate module of high reliability as claimed in claim 1, wherein said light-emitting source is a plurality of light-emitting diodes disposed on a bent soft circuit board, and at least a reflective film disposed at the periphery of said soft circuit board is used to reflect light source of said light-emitting diodes into said light-transmitting plate.

18. A light-guiding plate module of high reliability used to provide a required uniform light source for a display, said light-guiding plate module comprising:
a light-transmitting plate comprising an upper and a lower light-guiding uniform plates, a light-focusing pattern being formed on said upper light-guiding uniform plate, a light-intercepting pattern being formed on said lower light-guiding uniform plate;
a reflective film disposed below said lower light-guiding uniform plate and having a shape corresponding to that of said lower light-guiding uniform plate; and
at least a light-emitting source disposed at least at a side of said light-transmitting plate.

19. The light-guiding plate module of high reliability as claimed in claim 18, wherein the shape of said lower light-guiding uniform plate is selected among an arc-shaped plane, a paraboloid, a hyperboloid, a butting double wedged plate, and a multiply-bent plane.

20. The light-guiding plate module of high reliability as claimed in claim 18, wherein said light-focusing pattern is a pattern of V-shaped continuous grooves or a pattern of V-shaped alternate grooves.

21. The light-guiding plate module of high reliability as claimed in claim 18, wherein said light-intercepting pattern can be a pattern of distributed circular points, a pattern of distributed rectangular points, a pattern of distributed square points, a pattern of distributed hexagonal points, a pattern of distributed semicircular points, a pattern of distributed semilunar points, a pattern of semispherical raised points, a pattern of diamonds, a pattern of trapezoid grooves, a pattern of slantingly V-shaped continuous grooves, or a pattern of V-shaped alternate grooves.

22. The light-guiding plate module of high reliability as claimed in claim 18, wherein said light-focusing pattern and said light-intercepting pattern on said upper and lower light-guiding uniform plates can form denser or sparser patterns according to their distances from said light-emitting source.

23. The light-guiding plate module of high reliability as claimed in claim 18, wherein the material of said light-transmitting plate is selected among optical grade acrylic, high molecule polymer, polycarbonate, glass, and quartz.

24. The light-guiding plate module of high reliability as claimed in claim 18, wherein said light-emitting source is a matrix composed of a plurality of light-emitting diodes.

25. The light-guiding plate module of high reliability as claimed in claim 24, wherein said plurality of light-emitting diodes are composed of a plurality of red light light-emitting diodes, green light light-emitting diodes, and blue light light-emitting diodes.

26. The light-guiding plate module of high reliability as claimed in claim 18, wherein said light-emitting source is a whole-sheet white light organic light-emitting diode or a whole-sheet white light electroluminescence device.

27. The light-guiding plate module of high reliability as claimed in claim 18, wherein said light-emitting source is a plurality of light units formed on a circuit board, and each said light unit is composed of a blue light organic light-emitting diode, a green light organic light-emitting diode, and a red light light-emitting diode.

28. The light-guiding plate module of high reliability as claimed in claim 18, wherein said light-emitting source is at least a long-sheet blue light organic light-emitting diode and at least a long-sheet green light organic light-emitting diode parallel spaced and alternately arranged on a circuit board, and a plurality of red light light-emitting diodes are uniformly disposed between each said blue light organic light-emitting diode and each said green light organic light-emitting diode.

29. The light-guiding plate module of high reliability as claimed in claim 18, wherein said light-emitting source is an FED utilizing electron beams to bombard a white light displaying light source composed of white fluorescent powder or combination of red, green, and blue fluorescent powder.

30. The light-guiding plate module of high reliability as claimed in claim 29, wherein a diffusive plate and a prism can be additionally disposed between said FED and said light-transmitting plate to enhance uniformity of light incident into said light-transmitting plate.

31. The light-guiding plate module of high reliability as claimed in claim 18, wherein said light-emitting source is a plurality of light-emitting diodes disposed on a bent soft circuit board, and at least a reflective film disposed at the periphery of said soft circuit board is used to reflect light source of said light-emitting diodes into said light-transmitting plate.

32. The light-guiding plate module of high reliability as claimed in claim 18, wherein two opposed side faces of said light-transmitting plate are symmetrical slanting planes with a slanting angle between 0 and 60 degrees.

33. The light-guiding plate module of high reliability as claimed in claim 32, wherein the central thickness of said light-transmitting plate can be increased along with increase of said slanting angle to reduce the difference between the side thickness and the central thickness of said light-transmitting plate and to enhance yield of mold ejection.
